(19) United States
(12) Patent Application Publication
(10) Pub. No.: US 2012/0200676 A1
(43) Pub. Date: Aug. 9, 2012

(54) Three-Dimensional Display with Motion Parallax

(75) Inventors: Christian Huitema, Clyde Hill, WA (US); Eric Lang, Yarrow Point, WA (US); Evgeny Salnikov, Redmond, WA (US)

(73) Assignee: MICROSOFT CORPORATION, Redmond, WA (US)

(21) Appl. No.: 13/022,787

(22) Filed: Feb. 8, 2011

(51) Int. Cl. H04N 13/04

(52) U.S. Cl. 348/51; 348/E13.026

(57) ABSTRACT

The subject disclosure is directed towards a hybrid stereo image/motion parallax system that uses stereo 3D vision technology for presenting different images to each eye of a viewer, in combination with motion parallax technology to adjust each image for the positions of a viewer's eyes. In this way, the viewer receives both stereo cues and parallax cues as the viewer moves while viewing a 3D scene, which tends to result in greater visual comfort/less fatigue to the viewer. Also described is the use of goggles for tracking viewer position, including training a computer vision algorithm to recognize goggles instead of only heads/eyes.

### BACKGROUND

The human brain gets its three-dimensional (3D) cues in multiple ways. One of these ways is via stereo vision, which corresponds to the difference between viewed images presented to the left and right eye. Another way is by motion parallax, corresponding to the way a viewer's view of a scene changes when the viewing angle changes, such as when the viewer's head moves.

Current 3D displays are based upon stereo vision. In general, 3D televisions and other displays output separate video frames to each eye via 3D goggles or glasses with lenses that block certain frames and pass other frames through. Examples include using two different colors for the left and right images with corresponding filters in the goggles, using the polarization of light and corresponding different polarization for the left and right images, and using shutters in the goggles. The brain combines the frames in way that viewers experience 3D depth as a result of the stereo cues.

Recent technology allows different frames to be directed to each eye without glasses, accomplishing the same result. Such displays are engineered to present different views from different angles, typically by arranging the screen's pixels between some kind of optical barrier or optical lenses.

Three-dimensional display technology works well when the viewer's head is mostly stationary. However, the view does not change when the viewer's head moves, whereby the stereo cues contradict the motion parallax. This contradiction causes some viewers to experience fatigue and discomfort when viewing content on 3D displays.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a hybrid stereo image/motion parallax technology that uses stereo 3D vision technology for presenting different images to each eye of a viewer, in combination with motion parallax technology to adjust rendering or acquisition of each image for the positions of a viewer's eyes. In this way, the viewer receives both stereo cues and parallax cues as the viewer moves while viewing a 3D scene.

In one aspect, the left and right images captured by a stereo camera and received and processed for motion parallax adjustment according to position sensor data that corresponds to a current viewer position. These adjusted images are then output for separate left and right display to a viewer's left eye and right eye, respectively. Alternatively, the current viewer position may be used to acquire the images of the scene, e.g., by correspondingly moving a robot stereo camera. The technology also applies to multiple viewers viewing the same scene, including on the same screen if independently tracked and given an independent view.

In one aspect, viewer head and/or eye position is tracked. Note that eye position may be tracked directly for each eye or estimated for each eye from head tracking data, which may include the head position in 3D space plus the head's gaze direction (and/or rotation, and possibly more, such as tilt) and thus provides data corresponding to a position for each eye. Thus, “position data” includes the concept of the position of each eye regardless of how obtained, e.g., directly or via estimation from head position data.

Goggles with sensors or transmitters may be used in the tracking, including the same 3D filtering goggles that use lenses or shutters for passing/blocking different images to the eyes; (note that as used herein, a “shutter” is a type of filter, that is, a timed one). Alternatively, computer vision may be used to track the head or eye position, particularly for use with goggle-free 3D display technology. Notwithstanding, a computer vision system may be trained to track the position of goggles or the lens or lenses of goggles.

Tracking the current viewer position corresponding to each eye further allows for images to be acquired or adjusted based on both horizontal parallax and vertical parallax. Thus, tilt, viewing height and head rotation/tilt data for example also may be used in adjusting or acquiring images, or both.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a representation of a viewer viewing a stereo display in which a stereo camera provides left and right stereoscopic images.

FIG. 2 is a representation of a viewer viewing a stereo display in which a left and right camera provide left and right stereo images, and motion parallax processing adjusts rendering of each image based on the current left and right eye positions of the viewer.

FIG. 3 is a flow diagram representing example steps for performing motion parallax processing on separate left and right images.

FIG. 4 is a block diagram representing an exemplary non-limiting computing system or operating environment in which one or more aspects of various embodiments described herein can be implemented.

### DETAILED DESCRIPTION

Various aspects of the technology described herein are generally directed towards a hybrid stereo image/motion parallax system that uses stereo 3D vision technology for presenting different images to each eye, in combination with motion parallax technology to adjust the left and right images for the positions of a viewer's eyes. In this way, the viewer receives both stereo cues and parallax cues as the viewer moves while viewing a 3D scene, which tends to result in greater visual comfort/less fatigue to the viewer. To this end, the position of each eye (or goggle lens, as described below) may be tracked, directly or via estimation. A 3D image of a scene is rendered in real time for each eye using a perspective projection computed from the point of view of the viewer, thereby providing parallax cues.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in display technology in general.

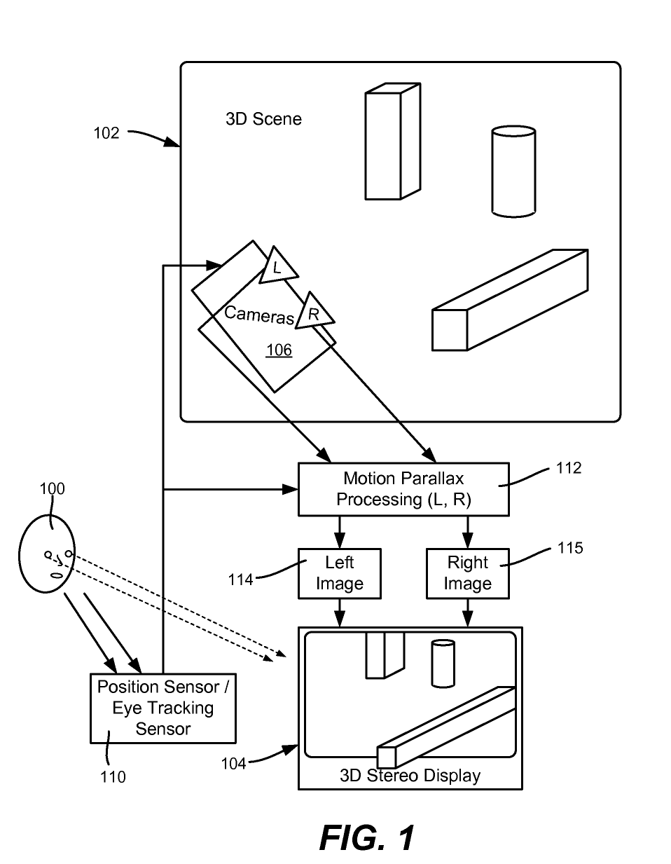

FIG. 1 is a representation of a viewer 100 viewing a 3D scene 102 shown on a 3D stereo display 104 as captured by left and right stereo cameras 106. In FIG. 1, the viewer's eyes may be assumed to be in a starting position (with zero motion parallax). Note that one of the objects in the scene 102 is represented as appearing to come out of the display to indicate that the scene is showing separate left and right images perceived by the viewer 100 as 3D.

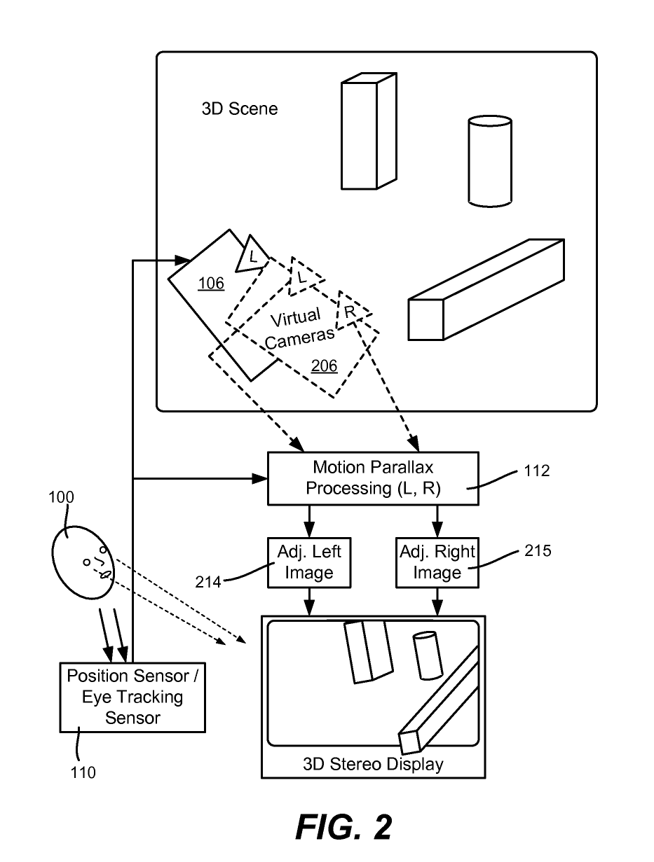

FIG. 2 is a is a representation of the same viewer 100 viewing the same 3D scene 102 through the 3D stereo display 104 as captured by left and right stereo cameras 106; however in FIG. 2 the viewer has moved relative to FIG. 1. Example movements include vertical and/or horizontal movement, rotation of the head, pitch and/or tilt of the head. As such, the eye positions sensed or estimated from data of a position sensor/eye tracking sensor 110, (e.g., estimated from head position data which may include 3D position, rotation, direction, tilt and so forth), are different from one another. Examples of such position sensors/eye tracking sensors are described below.

As is known in single image (“mono”) parallax scenarios, the image captured by a camera can be adjusted by relatively straightforward geometric computations to match a viewer's general head position and thus the horizontal viewing angle. For example, head tracking systems based on camera and computer vision algorithms have been used to implement a “mono 3D” effect, as explained for example in Cha Zhang, Zhaozheng Yin and Dinei Florêncio, “Improving Depth Perception with Motion Parallax and Its Application in Teleconferencing.” Proceedings of MMSP'09, Oct. 5-7, 2009, http://research.microsoft.com/en-us/um/people/chazhang/publications/mmsp09_ChaZhang.pdf. In such a mono-parallax scenario, a “virtual” camera basically exists that seems to move within the scene being viewed as the viewer's head moves horizontally. However, no such known technology works with separate left and right images, and thus stereo images are not contemplated. Moreover, head tilt, viewing height and/or head rotation do not change the viewed image.

Instead of a virtual camera, it is understood that the cameras of FIG. 1 a stereo robotic camera that moves in a real environment to capture the scene from different angles, such as by moving to the same position/orientation as the virtual cameras 206 of FIG. 2. Another alternative is to adjust prerecorded single stereo video, or interpolate the video from multiple stereo cameras that are capturing/recording a 3D scene from various angles. As such, the three-dimensional display with motion parallax technology described herein works in part by acquiring and/or adjusting left and right images based upon the sensed viewer position data.

As described herein, motion parallax processing is performed by a motion parallax processing component 112 for left and right images, providing parallax adjusted left and right images 114 and 115, respectively. Note that it is feasible to estimate the eyes' positions from head (or single eye) position data, however this cannot adjust for head tilt, pitch and and/or head gaze rotation/direction unless more information about the head than only its general position is sensed and provided as data to the motion parallax processing component. Accordingly, the sensed position data also may include head tilt, pitch and/or head rotation data.

Thus, as generally represented in FIG. 2, virtual left and right (stereo) cameras 206 may effectively move, rotate and/or tilt with the viewer's position. Robotic cameras or processed images of multiple cameras can do the same. The viewer thus sees the 3D scene via left and right stereo images 214 and 215, respectively, each adjusted for parallax compensation. Note that the objects shown in FIG. 2 are intended to represent the same objects shown from a different perspective as those in FIG. 1, but this is only for purposes of illustration, and the relative sizes and/or perspective are not intended to be mathematically accurate in the drawings.

In summary, as generally represented in FIGS. 1 and 2, the position of the viewer 100 relative to the display is assessed by a position sensor/eye sensor 110. The viewer's position is used to drive a set of left and right virtual cameras 206 that effectively look at the 3D scene from the virtual position of the viewer in that scene. The virtual camera 206 captures two images, corresponding to the left and right eye views. The two images are presented by the stereo display, providing the viewer 100 with a 3D view.

As the viewer 110 moves, the position of the viewer is tracked in real time, and translated into corresponding changes in both the left and right images 214 and 215. This results in an immersive 3D experience that combines both stereo cues and motion parallax cues.

Turning to aspects related to position/eye tracking, such tracking may be accomplished in various ways. One way includes multi-purpose goggles that combine stereo filters and a head-tracking device, e.g., implemented as sensors or transmitters in the goggle's stems. Note that various eyewear configured to output signals for use in head-tracking, such as including transmitters (e.g., infrared) that are detected and triangulated, are known in the art. Magnetic sensing is another known alternative.

Another alternative is to use head tracking systems based on camera and computer vision algorithms. Autostereoscopic displays that direct light to individual eyes, and thus are able to provide separate left and right image viewing for 3D effects, are described in U.S. patent application Ser. Nos. 12/819,238, 12/819,239 and 12/824,257, hereby incorporated by reference. Microsoft Corporation's Kinect™ technology has been adapted for head tracking/eye tracking in one implementation.

In general, the computer vision algorithms for eye tracking use models based on the analysis of multiple images of human heads. Standard systems may be used with displays that do not require goggles. However, when the viewer is wearing goggles, a practical problem arises in that goggles cover the eyes, and thus cause many existing face tracking mechanisms to fail. To overcome this issue, in one implementation, face tracking systems are trained with a set of images of people wearing goggles (instead of or in addition to training with images of normal faces). Indeed, a system may be trained with a set of images of people wearing the specific goggles used by a particular 3D system. This results in very efficient tracking, as goggles tend to stand out as a very recognizable object in the training data. In this way, a computer vision-based eye tracking system may be tuned to account for the presence of goggles.

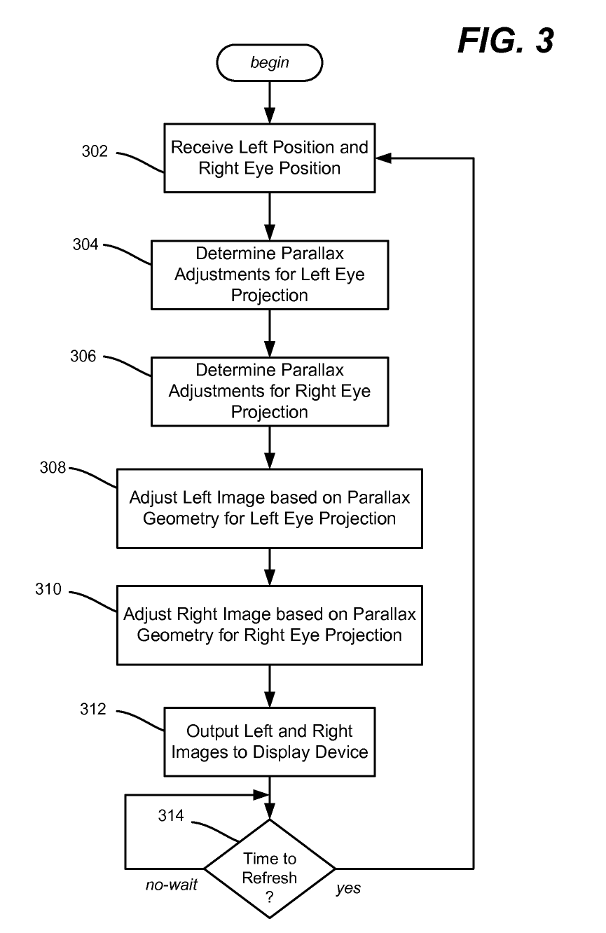

FIG. 3 is a flow diagram showing example steps of a motion parallax processing mechanism configured to separately compute left and right images. As represented by step 302, the process receives left and right eye position data from the position/eye tracking sensor. As described above, head position data alternatively may be provided and used for the parallax computations, including by converting the head position data to left and right eye position data.

Step 304 represents computing the parallax adjustments based upon the geometry of the viewer's left eye position. Step 306 represents computing the parallax adjustments based upon the geometry of the viewer's right eye position. Note that it is feasible to use the same computation for both eyes, such as if obtained as head position data and rotation and/or tilt are not being considered, since the stereo camera separation already provides some (fixed) parallax differences. However even the small two-inch or so distance between eyes makes a difference in parallax and the resulting viewer perception, including when rotating/tilting the head, and so forth.

Steps 308 and 310 represent adjusting each image based on the parallax-projection computations. Step 312 outputs the adjusted images to the display device. Note that this may be in a conventional signal provided to a conventional 3D display device, or may be separate left and right signals to a display device configured to receive separate images. Indeed, the technology described herein may incorporate the motion parallax processing component 112 (and possibly the sensor or sensors 110) in the display device itself, for example, or may incorporate the motion parallax processing component 112 into the cameras.

Step 314 repeats the process, such as for every left and right frame (or a group of frames/time duration, since a viewer can only move so fast). Note that alternatives are feasible, e.g., the left image parallax adjustment and output make take turns with the right image parallax adjustment and output, e.g., the steps of FIG. 3 need not occur in the order exemplified. Also, instead of refreshing every frame or group of frames/time duration, for example, a threshold amount of movement may be detected to trigger a new parallax adjustment. Such less frequent parallax adjustment processing may be desirable in a multiple viewer environment so that computation resources can be distributed among the multiple viewers.

Indeed, while the technology described herein has been described with reference to a single viewer, it is understood that multiple viewers of the same display can each receive his or her own parallax adjusted stereo image. Displays that can direct different left and right images to multiple viewers' eyes are known (e.g., as described in the aforementioned patent applications), and thus as long as the processing power is sufficient to sense multiple viewers' positions and perform the parallax adjustments, multiple viewers can simultaneously view the same 3D scene with individual stereo and left and right parallax adjusted views.

As can be seen, there is described herein a hybrid 3D video system that combines stereo display with dynamic composition of the left and right images to enable motion parallax rendering. This may be accomplished by inserting a position sensor in motion parallax goggles, including motion parallax goggles with separate filtering lenses, and/or by computer vision algorithms for eye tracking. Head tracking software may be tuned to account for the viewer wearing goggles.

The hybrid 3D system may be applied to video and/or to graphic applications that display a 3D scene, and thereby allow viewers to physically or otherwise navigate through various parts of a stereo image. For example, displayed 3D scenes may correspond to video games, 3D teleconferences, and data representations.

Moreover, the technology described herein overcomes a significant flaw with current display technology that takes into account only horizontal parallax, namely by also adjusting for vertical parallax, (provided shutter glasses are used, or that the display is able to direct light both horizontally and vertically, unlike some lenticular or other goggle-free technology that can only produce horizontal parallax). The separate eye tracking/head sensing described herein may correct parallax for any head position, (e.g., tilted sideways some number of degrees).

### Exemplary Computing Device

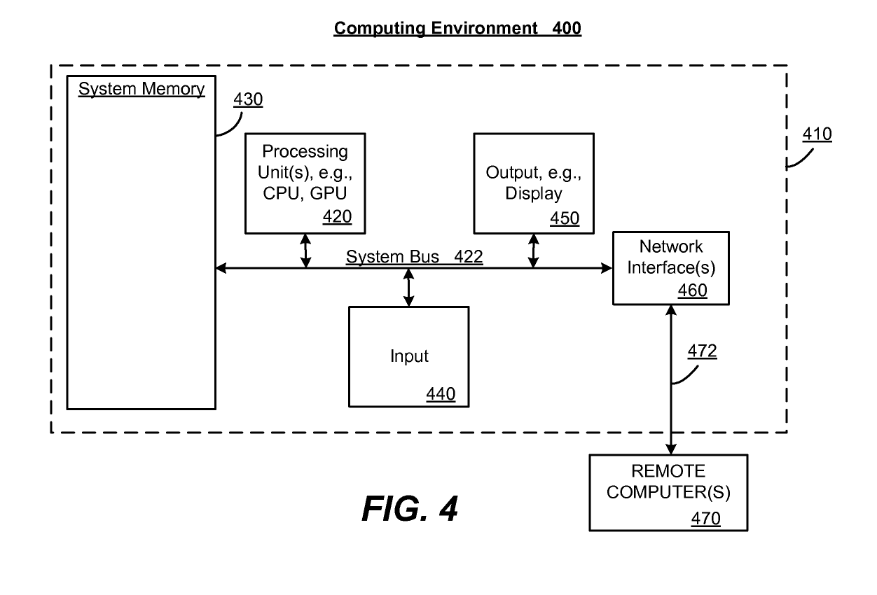

The techniques described herein can be applied to any device. It can be understood, therefore, that handheld, portable and other computing devices and computing objects of all kinds are contemplated for use in connection with the various embodiments. Accordingly, the below general purpose remote computer described below in FIG. 4 is but one example of a computing device, such as configured to receive the sensor output and perform the image parallax adjustments as described above.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 4 thus illustrates an example of a suitable computing system environment 400 in which one or aspects of the embodiments described herein can be implemented, although as made clear above, the computing system environment 400 is only one example of a suitable computing environment and is not intended to suggest any limitation as to scope of use or functionality. In addition, the computing system environment 400 is not intended to be interpreted as having any dependency relating to any one or combination of components illustrated in the exemplary computing system environment 400.

With reference to FIG. 4, an exemplary remote device for implementing one or more embodiments includes a general purpose computing device in the form of a computer 410. Components of computer 410 may include, but are not limited to, a processing unit 420, a system memory 430, and a system bus 422 that couples various system components including the system memory to the processing unit 420.

Computer 410 typically includes a variety of computer readable media and can be any available media that can be accessed by computer 410. The system memory 430 may include computer storage media in the form of volatile and/or nonvolatile memory such as read only memory (ROM) and/or random access memory (RAM). By way of example, and not limitation, system memory 430 may also include an operating system, application programs, other program modules, and program data.

A viewer can enter commands and information into the computer 410 through input devices 440. A monitor or other type of display device is also connected to the system bus 422 via an interface, such as output interface 450. In addition to a monitor, computers can also include other peripheral output devices such as speakers and a printer, which may be connected through output interface 450.

The computer 410 may operate in a networked or distributed environment using logical connections to one or more other remote computers, such as remote computer 470. The remote computer 470 may be a personal computer, a server, a router, a network PC, a peer device or other common network node, or any other remote media consumption or transmission device, and may include any or all of the elements described above relative to the computer 410. The logical connections depicted in FIG. 4 include a network 472, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor, comprising:
(a) receiving sensed position data corresponding to a current viewer position;
(b) using the position data to adjust or acquire from a scene, or both, a left eye image to account for parallax corresponding to the current viewer position, and a right eye image to account for parallax corresponding to the current viewer position;
(c) outputting the left image for display to the viewer's left eye;
(d) outputting the right image for display to the viewer's right eye;
(e) returning to step (a) to provide a motion parallax-adjusted stereoscopic representation of a scene to the viewer.

2. The method of claim 1 further comprising, tracking viewer head position to provide at least part of the sensed position data.

3. The method of claim 2 wherein tracking the viewer head position comprises sensing the head position based upon one or more sensors attached to goggles, in which the goggles include lenses configured for stereoscopic viewing.

4. The method of claim 2 wherein tracking the viewer head position comprises sensing the head position based upon one or more transmitters attached to goggles, in which the goggles include lenses configured for stereoscopic viewing.

5. The method of claim 2 wherein tracking the viewer head position comprises executing a computer vision algorithm.

6. The method of claim 2 further comprising, training the computer vision algorithm with a set of data corresponding to people wearing goggles.

7. The method of claim 1 further comprising, tracking viewer eye position, or viewer eye position, rotation and gaze direction.

8. The method of claim 7 wherein tracking the viewer eye position comprises executing a computer vision algorithm.

9. The method of claim 1 further comprising, tracking viewer eye position separately for left and right eyes.

10. The method of claim 1 further comprising, tracking viewer goggle lens position.

11. The method of claim 10 further comprising, training the computer vision algorithm with a set of data corresponding to people wearing goggles.

12. The method of claim 1 wherein using the position data comprises, adjusting the left image for horizontal and vertical position, rotation pitch and tilt, and adjusting the right image for horizontal and vertical position, rotation pitch and tilt.

13. The method of claim 1 further comprising:
(i) receiving sensed position data corresponding to a current other viewer position;
(ii) using the position data to adjust or acquire from a scene, or both, a left eye image to account for parallax corresponding to the current other viewer position, and a right eye image to account for parallax corresponding to the current other viewer position;
(iii) outputting the left image for display to the other viewer's left eye;
(iv) outputting the right image for display to the other viewer's right eye;
(v) returning to step (i) to provide a motion parallax-adjusted stereoscopic representation of a scene to the other viewer.

14. In a computing environment, a system comprising, a position tracking device configured to output position data corresponding to a viewer position, a motion parallax processing component configured to receive position data from the motion tracking device, and left image data and right image data from a stereo camera, the motion parallax processing component further configured to adjust the left image data based on the position data, and to adjust the right image data based on the position data, and to output corresponding adjusted left and right image data to a display device.

15. The system of claim 14 wherein the position tracking device tracks the viewer's head position.

16. The system of claim 14 wherein the position tracking device tracks the position of at least one of the viewer's eyes.

17. The system of claim 14 wherein the position tracking device tracks the position of goggles worn by the viewer or the position of at least one of the goggles lenses.

18. One or more computer-readable media having computer-executable instructions, which when executed perform steps, comprising:
receiving a series of left images, at least some of the left images adjusted for motion parallax;
outputting the series of left images for display to the viewer's left eye;
receiving a series of right images, at least some of the right images adjusted for motion parallax; and
outputting the series of right images for display to the viewer's right eye.

19. The one or more computer-readable media of claim 18 wherein outputting the series of left images for display to the viewer's left eye comprises configuring the series of left images for passing through a filter in front of the viewer's left eye and being blocked by a filter in front of the viewer's right eye, and wherein outputting the series of right images for display to the viewer's right eye comprises configuring the series of right images for passing through a filter in front of the viewer's right eye and being blocked by a filter in front of the viewer's left eye.

20. The one or more computer-readable media of claim 18 wherein outputting the series of left images for display to the viewer's left eye comprises directing the left images to a computed or sensed left-eye position, and wherein outputting the series of right image for display to the viewer's right eye comprises directing the right images to a computed or sensed right-eye position.
